(19) United States
(12) Patent Application Publication
(10) Pub. No.: US 2025/0287138 A1
(43) Pub. Date: Sep. 11, 2025

(54) TUNING SPRING MASS RESONATOR OF LOUDSPEAKER IN MOBILE DEVICE

(71) Applicant: Microsoft Technology Licensing, LLC, Redmond, WA (US)

(72) Inventors: Christian LORENZ, Redmond, WA (US); Kalle Ilari MAKINEN, Nokia (FI); Tuomas Erkki NIEMI, Ylojarvi (FI); Eric Andrew SIMPSON, Carnation, WA (US)

(73) Assignee: Microsoft Technology Licensing, LLC, Redmond, WA (US)

(21) Appl. No.: 18/861,980

(22) PCT Filed: Apr. 25, 2023
(86) PCT No.: PCT/US2023/019805

§ 371 Date: Oct. 31, 2024

(30) Foreign Application Priority Data
May 20, 2022 (NL) 2031944

(51) Int. Cl. H04R 1/22

(52) U.S. Cl. CPC H04R 1/22; H04R 2499/11; H04R 2499/15

(57) ABSTRACT

Mobile computing devices and methods for manufacturing mobile computing devices and tuning a spring mass resonator of a distributed mode loudspeaker in such devices are disclosed. A mobile computing device includes a display to which the spring mass resonator is affixed. At least one component of the spring mass resonator is modified to increase a frequency response of the display within at least a portion of a frequency range between 350 Hz. and 700 Hz.

### BACKGROUND

In some devices, a flat panel audio loudspeaker utilizes one or more actuators to induce vibration modes in a panel.

### SUMMARY

According to one aspect of the present disclosure, a method is provided for tuning a spring mass resonator of a distributed mode loudspeaker in a mobile computing device. The mobile computing device comprises a display to which the spring mass resonator is affixed. The method includes modifying at least one component of the spring mass resonator to increase a frequency response of the display within at least a portion of a frequency range between 350 Hz. and 700 Hz.

Another aspect of the present disclosure provides a method of manufacturing a mobile computing device. The mobile computing device comprises a distributed mode loudspeaker that includes a spring mass resonator affixed to a display, a chassis comprising a rear surface, and an internal component between the rear surface and the display. The method comprises configuring the internal component and the display to define an air gap having a width of between 0.1 mm and 0.6 mm, and modifying at least one component of the spring mass resonator to increase a frequency response of the display within at least a portion of a frequency range between 350 Hz. and 700 Hz.

Another aspect of the present disclosure provides a mobile computing device comprising a distributed mode loudspeaker that comprises a spring mass resonator affixed to a display of the mobile computing device, a chassis comprising a rear surface, and an internal component between the rear surface and the display. The internal component and the display are spaced apart to define an air gap having a width of between 0.1 mm and 0.6 mm. At least one component of the spring mass resonator is configured to operatively increase a frequency response of the display within at least a portion of a frequency range between 350 Hz. and 700 Hz.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows one example of a mobile computing device according to examples of the present disclosure.

FIG. 2 is a partial exploded view of the mobile computing device of FIG. 1.

FIG. 3 is a schematic cross-sectional view taken along line 3-3 of FIG. 1 showing a spring mass resonator and battery of the mobile computing device according to examples of the present disclosure.

FIG. 4 is a schematic cross-sectional view of one example of a spring mass resonator that may be utilized with the mobile computing device according to examples of the present disclosure.

FIG. 5 shows plots of frequency response in relation to injection force introduced by a spring mass resonator for untuned and tuned spring mass resonators according to examples of the present disclosure.

FIG. 6 shows a block diagram of an example method for tuning a spring mass resonator of a distributed mode loudspeaker in a mobile computing device according to examples of the present disclosure.

FIG. 7 shows a block diagram of an example method of manufacturing a mobile computing device according to examples of the present disclosure.

FIG. 8 shows a block diagram of an example computing system according to examples of the present disclosure.

### DETAILED DESCRIPTION

As introduced above, some devices include a flat panel audio loudspeaker that generates sound via one or more actuators or exciters inducing vibration modes in a panel. In some instances of smaller form factor devices, such as a mobile phone, a small earpiece speaker is provided for use against a user's ear or within a very short range, such as within 5 centimeters (cm). The diminutive size of such earpiece speakers makes them unsuitable for producing high quality sound that can be comfortably heard at greater distances, such as 30 cm and beyond. Additionally, smaller form factor devices have limited packaging space for internal components. In these devices, small air gaps between components and a panel can create significant air stiffness effects that impede the vibration of a panel, especially in lower frequency ranges.

To address one or more of these issues, examples are disclosed that relate to tuning a spring mass resonator of a distributed mode loudspeaker in a mobile computing device. In the examples described below, a mobile computing device comprises a display to which the spring mass resonator is affixed. The method includes modifying at least one component of the spring mass resonator to increase a frequency response of the display within at least a portion of a frequency range between 350 Hz. and 700 Hz. Advantageously and as described in more detail below, tuning the spring mass resonator as described herein operates to boost the frequency response of the display by increasing sensitivity around the first fundamental mode of the display, thereby creating a loudspeaker with consistent and aurally pleasing sound pressure levels throughout frequency ranges spanning these lower frequencies.

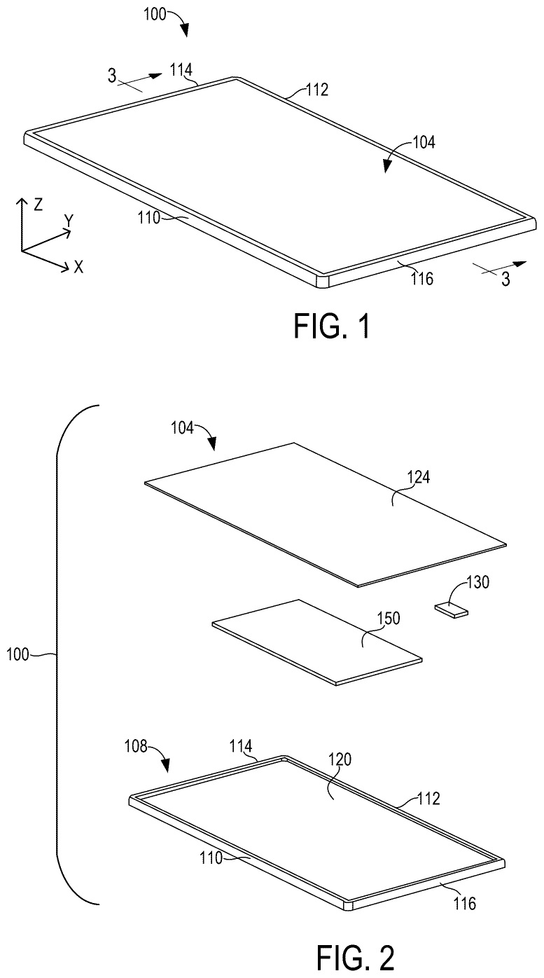

FIGS. 1-3 show one example of a mobile computing device 100 according to aspects of the present disclosure. As described in more detail below, the mobile computing device 100 includes a display 104 that is also utilized as a speaker membrane in a distributed mode loudspeaker configuration. In different examples, the mobile computing device 100 can take the form of a smartphone, tablet-style device, or other small form-factor computing device. In some examples, the methods of the present disclosure may be utilized with a mobile computing device in the form of a foldable, dual-screen mobile computing device. In these examples, one or both screens can be utilized as a speaker membrane of a distributed mode loudspeaker. It will also be appreciated that the methods and devices disclosed herein may also apply to other form factors and configurations of mobile computing devices.

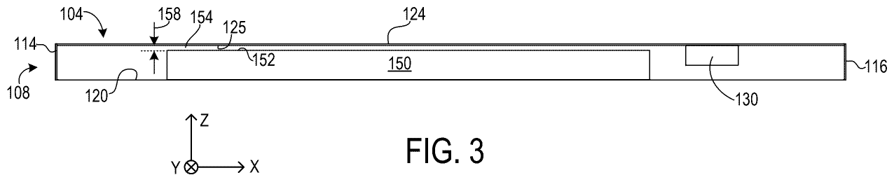

With reference now to FIGS. 2 and 3, in this example the mobile computing device 100 includes a chassis 108 having side walls 110, 112 and end walls 114, 116. The chassis further includes a rear surface 120 that forms a shallow enclosure together with side walls 110, 112 and end walls 114, 116.

As described in more detail below, the display 104 includes an outer substrate 124 that functions as a panel of a distributed mode loudspeaker via an attached spring mass resonator 130. In the present example the outer substrate 124 can be formed of glass, though in other examples other suitable materials may be utilized. In the present example, the outer substrate has a diagonal size of approximately 15 cm. In different examples the display 104 can be a touch screen display or a non-touch screen display. In examples of touch screen displays, a variety of touch detection technologies may be utilized, such as mutual capacitance, self-capacitance, and projected capacitance touch detection. In some examples, the display 104 can comprise multiple layers and/or substrates that comprise a touch detection module and/or structures for displaying images. The display 104 can utilize any suitable display technology, such as Organic Light Emitting Diode (OLED), liquid crystal displays (LCDs), or other light-emitting structures.

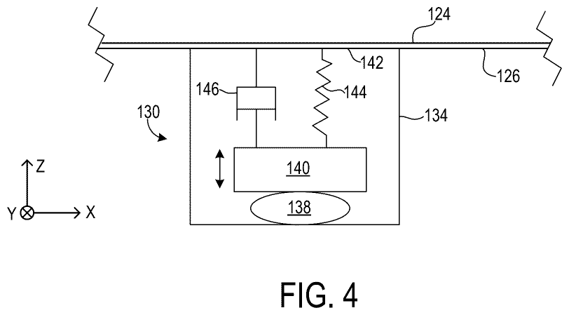

In different examples the spring mass resonator 130 may take a variety of forms. Examples of suitable spring mass resonators 130 include moving magnet/coil exciters and piezoelectric devices. In the present example and with reference now to FIG. 4, spring mass resonator 130 includes a housing 134 that encloses a motor 138 configured to drive a mass component 140 in the positive and negative z-axis direction (e.g., toward and away from the outer substrate 124 of the display 104). The mass component 140 is connected to a mounting plate 142 of the housing 134 via a spring 144 and a damping component 146. The mounting plate is affixed to a bottom surface 126 of the outer substrate 124.

The damping component 146 is configured to create a controlled mechanical loss in the movement of the mass component 140. In different examples the damping component 146 can take a variety of forms, including but not limited to pneumatic, hydraulic, and friction-based mechanisms. In the present example, the mechanical losses introduced by damping component 146 can function to widen resonance peaks of the frequency response of the distributed mode loudspeaker. In other examples of the present disclosure, the spring mass resonator 130 does not include a damping component.

During operation of the spring mass resonator 130, the mass component 140 is driven by motor 138 to oscillate in the z-axis direction and transfer the resulting vibrations to the outer substrate 124 of the display 104 via spring 144 and damping component 146. In this manner, the vibrating outer substrate 124 generates audible sound waves, such as in frequency ranges between approximately 20 Hz. and 20 KHz.

As noted above, smaller form factor devices such as smartphones have limited packaging space for internal components. Accordingly, the small spacings between these components can create similarly small air gaps. In the present example and with reference again to FIGS. 2 and 3, computing device 100 includes an internal component in the form of a battery 150 that occupies a significant portion of the packaging space internal to the chassis 108 of the device. In different examples, the battery 150 can occupy 50%, 60%, 70% or more of the internal packaging space of a device. As shown in FIG. 3, the battery 150 is located between the rear surface 120 of chassis 108 and a lower surface 125 of the outer substrate 124 of the display 104. The upper surface 152 of the battery 150 and the lower surface 125 of the outer substrate 124 define a small air gap 154. In different examples, the air gap 154 can have a width 158 between 0.1 mm and 0.6 mm, or between 0.2 mm and 0.5 mm, or between 0.3 and 0.4 mm. As noted above, air gaps of these sizes between the display and an internal component of a computing device create air stiffness effects that impede the vibration of the display, especially in lower frequency ranges.

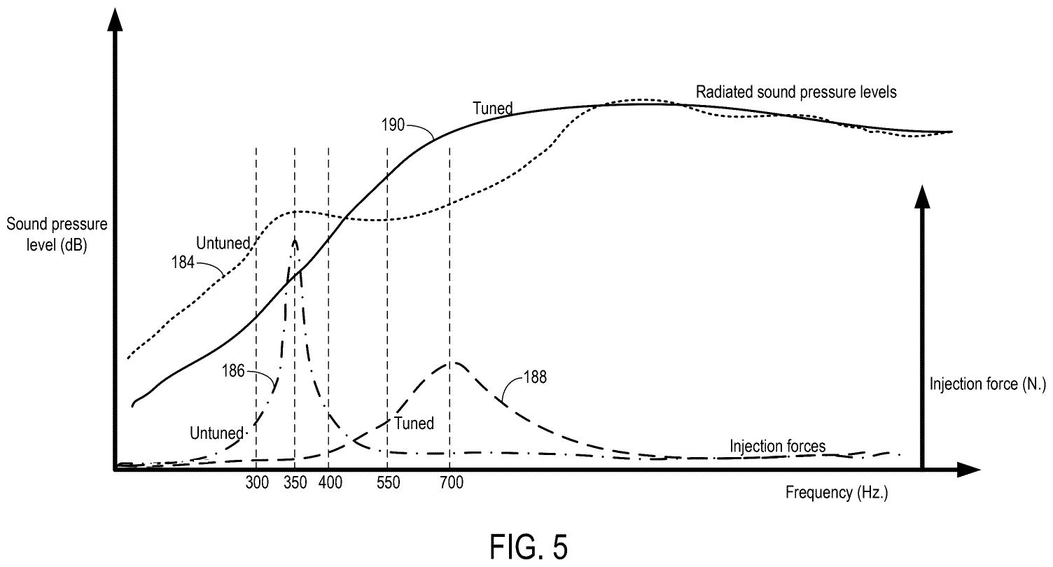

With reference now to FIG. 5, one example of the air stiffness effects of a small air gap, such as air gap 154, is illustrated. In the plots shown in FIG. 5, the upper dashed line 184 represents the radiated sound pressure levels generated by the display 104 when utilized as a speaker membrane in a distributed mode loudspeaker with the spring mass resonator 130 in an untuned condition as described further below. For example, an untuned condition may comprise an off-the-shelf spring mass resonator with a mass component having an initial, factory-set mass and a spring having an initial, factory-set stiffness. The sound pressure levels are plotted over a range of vibration frequencies in the display 104 that correspond to a range of injection forces generated by the spring mass resonator 130. In this example and as shown by dashed line 184, at approximately 350 Hz. the sound pressure levels with the spring mass resonator 130 in the untuned condition reach a peak magnitude beyond which the levels begin declining. This first peak magnitude represents the first fundamental frequency of the untuned distributed mode loudspeaker comprising the display 104 and the spring mass resonator 130 in the untuned condition.

Correspondingly and as shown in the lower dash-dot line 186 that represents the injection force created by the vibrating spring mass resonator 130 in the untuned condition, around the first fundamental frequency of 350 Hz. the injection force quickly spikes to a peak magnitude at 350 Hz. and similarly quickly declines between 350 Hz. and 500 Hz, beyond which it remains fairly constant into the higher frequency ranges. With reference again to the upper dashed line 184, in this example this significant variation in injection force near the first fundamental frequency results in a significant attenuation in the sound pressure levels within a lower frequency range between the first fundamental mode of 350 Hz. and approximately 700 Hz. For example and as shown in the plot of dashed line 184, the radiated sound pressure levels of the untuned distributed mode loudspeaker of this device exhibit an untuned slope that changes from a positive slope at a frequency less than 350 Hz., such as 300 Hz., to a negative slope at another frequency between 350 Hz. and 700 Hz., such as 400 Hz.

Correspondingly, the audio quality of this configuration is impaired in this lower frequency range, with a user hearing audible discontinuities in lower frequency sounds. It will also be appreciated that in other examples of smaller form factor devices an untuned spring mass resonator can exhibit an injection force peak at a fundamental mode of between approximately 150 Hz. and 400 Hz., with the distributed mode loudspeaker of the device exhibiting corresponding attenuation in sound pressure levels within a lower frequency range between this first fundamental mode and approximately 600 Hz. to 700 Hz.

To address this undesirable attenuation in lower frequency ranges, and in one potential advantage of the present disclosure, configurations of the present disclosure provide methods for tuning the spring mass resonator of a distributed mode loudspeaker in a mobile computing device, and for manufacturing a mobile computing device comprising such a distributed mode loudspeaker, that boost the radiated sound pressure levels in these lower frequency ranges. More particularly and as described in more detail below, configurations of the present disclosure provide methods for tuning the spring mass resonator of a mobile computing device to increase a frequency response of the device's display within at least a portion of a frequency range between 350 Hz. and 700 Hz.

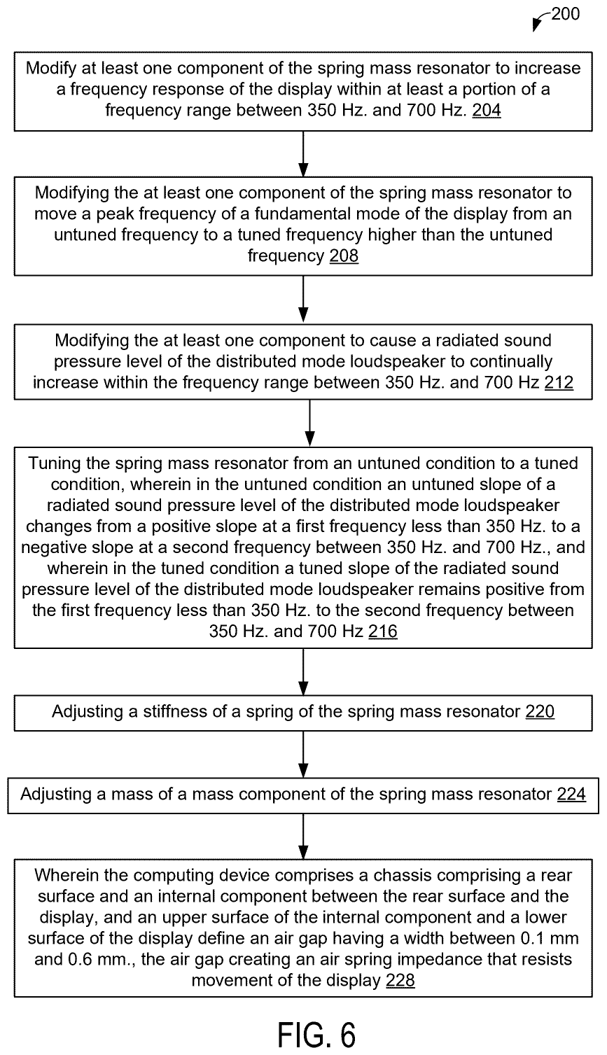

With reference now to FIG. 6, a flow diagram is provided depicting an example method 200 for tuning a spring mass resonator of a distributed mode loudspeaker in a mobile computing device. The following description of method 200 is provided with reference to the computing device 100 and components described herein and shown in FIGS. 1-5. In other examples, the method 200 can be performed in other contexts using other suitable mobile computing devices and/or components.

It will be appreciated that the following description of method 200 is provided by way of example and is not meant to be limiting. Therefore, it is to be understood that method 200 may include additional and/or alternative steps relative to those illustrated in FIG. 6. Further, it is to be understood that the steps of method 200 may be performed in any suitable order. Further still, it is to be understood that one or more steps may be omitted from method 200 without departing from the scope of this disclosure.

At 204, the method 200 includes modifying at least one component of the spring mass resonator to increase a frequency response of the display within at least a portion of a frequency range between 350 Hz. and 700 Hz. For example and with reference again to FIG. 5, one or more components of a spring mass resonator can be modified to selectively boost the radiated sound pressure levels within the frequency range of 350 Hz.-700 Hz that are generated by the display 104 with the spring mass resonator 130 in an untuned condition (represented by upper dashed line 184). As described in more detail below and as shown in the lower dashed line 188 of FIG. 5 (representing the injection force created by the vibrating spring mass resonator 130 in the tuned condition), by modifying one or more components of spring mass resonator 130 to thereby tune the spring mass resonator from an untuned condition to a tuned condition, the peak amplitude of the injection force created by the vibrating spring mass resonator 130 in the tuned condition (and correspondingly the first fundamental mode/frequency) is moved to a higher frequency value around 700 Hz. Accordingly, and with reference again to FIG. 6, at 208 the method 200 includes modifying at least one component of the spring mass resonator to move a peak frequency of a fundamental mode of the display from an untuned frequency (350 Hz. in this example) to a tuned frequency (700 Hz. in this example) higher than the untuned frequency. It will be appreciated that in other examples where the peak amplitude of the injection force created by the vibrating spring mass resonator 130 (and correspondingly the first fundamental mode/frequency) in the untuned condition is above 700 Hz., tuning the spring mass resonator 130 from an untuned condition to a tuned condition comprises reducing the peak amplitude of the injection force created by the vibrating spring mass resonator to a lower frequency value, such as around 700 Hz.

Additionally and as shown in the example of FIG. 5, the rate of change of the tuned injection force amplitude 188 preceding and following this tuned first fundamental mode/frequency is substantially reduced as compared to the steep untuned slope of the untuned injection force amplitude 186 preceding and following the untuned first fundamental mode/frequency at 350 Hz. Correspondingly, and in another potential advantage of the present disclosure, by modifying the one or more components of spring mass resonator 130 to tune the spring mass resonator 130, the tuned radiated sound pressure levels generated by the display 104 with the spring mass resonator 130 in the tuned condition (represented by upper solid line 190) exhibit a smooth and continual increase in amplitude within the frequency range between 350 Hz. and 700 Hz. Alternatively expressed, and as compared to the spring mass resonator 130 in the untuned condition, in the tuned condition a tuned slope of the radiated sound pressure level 190 of the distributed mode loudspeaker remains positive from a first frequency less than 350 Hz. to a second frequency between 350 Hz. and 700 Hz. In this manner, and in another potential advantage of the present disclosure, tuning the spring mass resonator 130 as described herein can improve the uniformity of audio output of the distributed mode loudspeaker over the audio frequency range of the speaker by reducing the attenuation in the low end of the audio range.

Accordingly and with reference again to FIG. 6, at 212 the method 200 includes modifying the at least one component of the spring mass resonator to cause a radiated sound pressure level of the distributed mode loudspeaker to continually increase within the frequency range between 350 Hz. and 700 Hz. Further, at 216 the method 200 includes, wherein in the untuned condition an untuned slope of a radiated sound pressure level of the distributed mode loudspeaker changes from a positive slope at a first frequency less than 350 Hz. to a negative slope at a second frequency between 350 Hz. and 700 Hz., and in the tuned condition a tuned slope of the radiated sound pressure level of the distributed mode loudspeaker remains positive from the first frequency less than 350 Hz. to the second frequency between 350 Hz. and 700 Hz. Advantageously, by tuning the spring mass resonator in this manner, the distributed mode loudspeaker of computing device 100 exhibits a more uniform, less-varying efficiency around the fundamental mode, thereby providing more stable audio quality to the listener.

With reference again to FIG. 6 and in some examples, at 220 the method 200 includes modifying at least one component of the spring mass resonator 130 by adjusting a stiffness of a spring of the spring mass resonator. With reference again to FIG. 4, in some examples the spring 144 of spring mass resonator 130 in the untuned condition can have an initial stiffness k. To tune the spring mass resonator 130 as described herein, the spring can be replaced or modified to have a tuned stiffness of k′ that is greater than k, thereby causing the peak amplitude of the injection force created by the vibrating spring mass resonator 130 in the tuned condition (the first fundamental mode/frequency) to move to a higher frequency value as described above. In this manner, and in another potential advantage of the present disclosure, modifying the spring stiffness of the spring mass resonator 130 provides a convenient and low-cost method for boosting the frequency response of the display by increasing sensitivity around the first fundamental mode of the display.

In one use case example, the mass component 140 of spring mass resonator 130 in the untuned condition has an initial mass of 2.5 grams (g.), the display 104 has a resonance frequency at a first fundamental mode of 250 Hz., and the spring 144 has a spring constant of k=6.2 kN/m. In this example and similar to the example plots of FIG. 5, the efficiency of the distributed mode loudspeaker formed by the display 104 exhibits high variation on the order of 10 dB in the low frequency regions around 250 Hz. Such variation results in a significant attenuation in the sound pressure levels within a lower frequency range between the first fundamental mode of 350 Hz. and 600 Hz.-700 Hz.

In this example, to tune the spring mass resonator 130 to move the first fundament mode resonance frequency to approximately 700 Hz., the spring 144 is adjusted to have a spring constant of k=48 kN/m. In one example, the spring 144 can be replaced by a stiffer spring having the foregoing spring constant. Advantageously and as described above, by tuning the spring mass resonator 130 in this manner and moving the fundamental mode of the display from an untuned frequency to a higher tuned frequency, attenuation in the low end of the audio range is reduced or substantially eliminated, and the uniformity of audio oututput of the distributed mode loudspeaker over the audio frequency range of the speaker is correspondingly improved.

At 224 and in other examples, the method 200 includes modifying at least one component of the spring mass resonator by adjusting a mass of a mass component of the spring mass resonator. With reference again to FIG. 4, in some examples the mass component 140 of spring mass resonator 130 in the untuned condition can have an initial mass of m. To tune the spring mass resonator 130 as described herein, the mass component 140 can be replaced or modified to have a tuned mass of m′ that is greater than m and that correspondingly causes the peak amplitude of the injection force created by the vibrating spring mass resonator 130 in the tuned condition (the first fundamental mode/frequency) to move to a higher frequency value as described above. In this manner, and in another potential advantage of the present disclosure, modifying the mass of the mass component 140 provides another convenient and low-cost method for boosting the frequency response of the display by increasing sensitivity around the first fundamental mode of the display.

In some examples, both the spring stiffness k of spring 144 and the mass m of mass component 140 can be adjusted to increase sensitivity around the first fundamental mode of the display and thereby improve the uniformity of audio oututput of the distributed mode loudspeaker over the audio frequency range of the speaker by reducing the attenuation in the low end of the audio range.

Returning to FIG. 6, at 228 and as described above, in some examples the method 200 can be performed with a computing device, such as computing device 100, that comprises a chassis comprising a rear surface and an internal component between the rear surface and the display, wherein an upper surface of the internal component and a lower surface of the display define an air gap having a width between 0.1 mm and 0.6 mm., with the air gap creating an air spring impedance that resists movement of the display. In other examples, method 200 can be performed to tune a spring mass resonator of a distributed mode loudspeaker in other mobile computing devices having different form factors and components.

Accordingly, and in another potential advantage of the present disclosure, the method 200 described above can be utilized to tune mobile computing devices to exhibit higher sensitivity and lower power consumption in lower frequency ranges, such as 350 Hz. to 700 Hz. In this manner, the displays of these devices can be utilized as distributed mode loudspeakers that feature a more uniform and less-varying efficiency around the first fundamental mode, thereby providing more consistent and aurally pleasing audio quality in these lower frequency ranges.

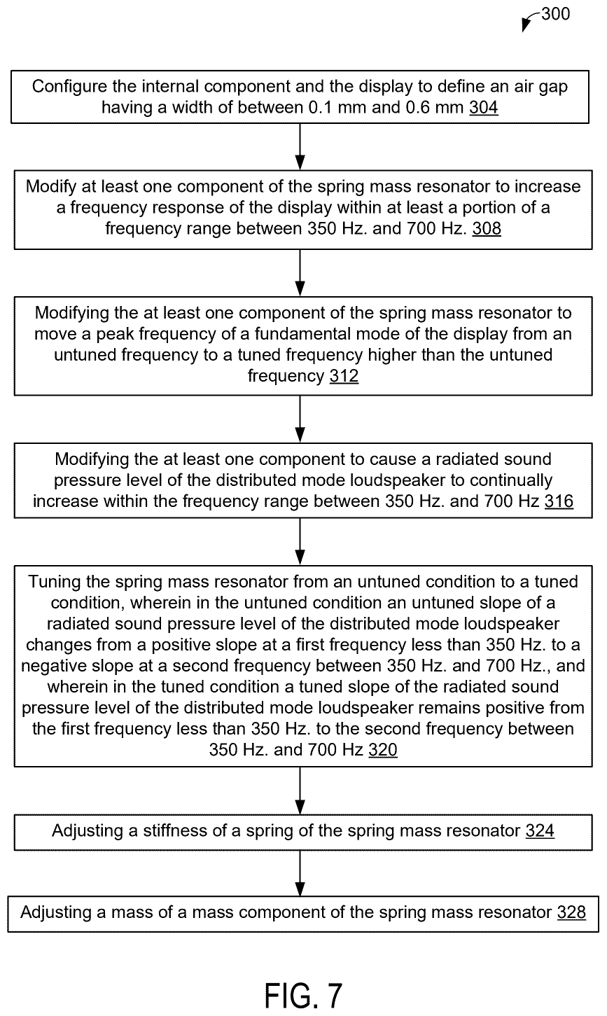

In some examples, the methods and techniques described herein can be utilized in manufacturing a mobile computing device, such as mobile computing device 100, that comprises a distributed mode loudspeaker as described above. With reference now to FIG. 7, a flow diagram is provided depicting an example method 300 for manufacturing a mobile computing device, where the mobile computing device comprises a distributed mode loudspeaker that comprises a spring mass resonator affixed to a display, a chassis comprising a rear surface, and an internal component between the rear surface and the display.

The following description of method 300 is provided with reference to the computing device 100 and components described herein and shown in FIGS. 1-5. In other examples, the method 300 can be performed in other contexts to manufacture other suitable mobile computing devices and/or components. It will be appreciated that the following description of method 300 is provided by way of example and is not meant to be limiting. Therefore, it is to be understood that method 300 may include additional and/or alternative steps relative to those illustrated in FIG. 7. Further, it is to be understood that the steps of method 300 may be performed in any suitable order. Further still, it is to be understood that one or more steps may be omitted from method 300 without departing from the scope of this disclosure.

At 304, the method 300 includes configuring an internal component of the computing device (in this example, battery 150) and the display to define an air gap having a width of between 0.1 mm and 0.6 mm. As described above, in the present example the upper surface 152 of the battery 150 and the lower surface 125 of the outer substrate 124 (display) define a small air gap 154 that can have a width 158 between 0.1 mm and 0.6 mm. At 308 the method 300 includes modifying at least one component of the spring mass resonator to increase a frequency response of the display within at least a portion of a frequency range between 350 Hz. and 700 Hz.

As noted above, one or more components of a spring mass resonator can be modified to selectively boost the radiated sound pressure levels within the frequency range 350 Hz.-700 Hz that are generated by the display 104 with the spring mass resonator 130 in an untuned condition (represented by dashed line 184 in FIG. 5). In this manner, the peak amplitude of the injection force created by the vibrating spring mass resonator 130 in the tuned condition (and correspondingly the first fundamental mode/frequency) is moved to a higher frequency value around 700 Hz. Accordingly, and with reference again to FIG. 7, at 312 the method 300 includes modifying at least one component of the spring mass resonator to move a peak frequency of a fundamental mode of the display from an untuned frequency to a tuned frequency higher than the untuned frequency.

Also as noted above, and in another potential advantage of the present disclosure, by modifying the one or more components of spring mass resonator 130 to tune the spring mass resonator, the tuned radiated sound pressure levels generated by the display 104 with the spring mass resonator 130 in the tuned condition (e.g., upper solid line 190 in FIG. 5) exhibit a smooth and continual increase in amplitude within the frequency range between 350 Hz. and 700 Hz. Alternatively expressed, and as compared to the spring mass resonator 130 in the untuned condition, in the tuned condition a tuned slope of the radiated sound pressure level 190 of the distributed mode loudspeaker remains positive from a first frequency less than 350 Hz. to a second frequency between 350 Hz. and 700 Hz.

Accordingly and with reference again to FIG. 7, at 316 the method 300 includes modifying the at least one component to cause a radiated sound pressure level of the distributed mode loudspeaker to continually increase within the frequency range between 350 Hz. and 700 Hz. Further, at 320 the method 300 includes, wherein in the untuned condition an untuned slope of a radiated sound pressure level of the distributed mode loudspeaker changes from a positive slope at a first frequency less than 350 Hz. to a negative slope at a second frequency between 350 Hz. and 700 Hz., and in the tuned condition a tuned slope of the radiated sound pressure level of the distributed mode loudspeaker remains positive from the first frequency less than 350 Hz. to the second frequency between 350 Hz. and 700 Hz. Advantageously, by tuning the spring mass resonator in this manner, the distributed mode loudspeaker of computing device 100 exhibits a more uniform, less-varying efficiency around the fundamental mode, thereby providing more stable audio quality to the listener.

With reference again to FIG. 7 and in some examples, at 324 the method 300 includes adjusting a stiffness of a spring of the spring mass resonator. As noted above, in some examples the spring 144 of spring mass resonator 130 in the untuned condition can have an initial stiffness k. To tune the spring mass resonator 130 as described herein, the spring can be replaced or modified to have a tuned stiffness of k′ that is greater than k, which correspondingly causes the peak amplitude of the injection force created by the vibrating spring mass resonator 130 in the tuned condition (the first fundamental mode/frequency) to move to a higher frequency value as described above. In this manner, and in another potential advantage of the present disclosure, modifying the spring stiffness of the spring mass resonator 130 provides a convenient and low-cost method for boosting the frequency response of the display by increasing sensitivity around the first fundamental mode of the display.

At 328 and in other examples, the method 300 includes adjusting a mass of a mass component of the spring mass resonator. Also as noted above, in some examples the mass component 140 of spring mass resonator 130 in the untuned condition can have an initial mass of m. To tune the spring mass resonator 130 as described herein, the mass component 140 can be replaced or modified to have a tuned mass of m′ that is greater than m and that correspondingly causes the peak amplitude of the injection force created by the vibrating spring mass resonator 130 in the tuned condition (the first fundamental mode/frequency) to move to a higher frequency value as described above. In this manner, and in another potential advantage of the present disclosure, modifying the mass of the mass component 140 provides another convenient and low-cost method for boosting the frequency response of the display by increasing sensitivity around the first fundamental mode of the display.

In some examples, manufacturing a mobile computing device can include modifying both the spring stiffness k of spring 144 and the mass m of mass component 140 to increase sensitivity around the first fundamental mode of the display, and thereby improve the uniformity of audio oututput of the distributed mode loudspeaker over the audio frequency range of the speaker by reducing the attenuation in the low end of the audio range.

Accordingly, and in another potential advantage of the present disclosure, mobile computing devices manufactured according to one or more aspects of the method 300 exhibit higher sensitivity and lower power consumption in lower frequency ranges, such as 350 Hz. to 700 Hz. In this manner, the displays of these devices can be utilized as distributed mode loudspeakers that feature a more uniform and less-varying efficiency around the first fundamental mode, thereby providing more consistent and aurally pleasing audio quality in these lower frequency ranges.

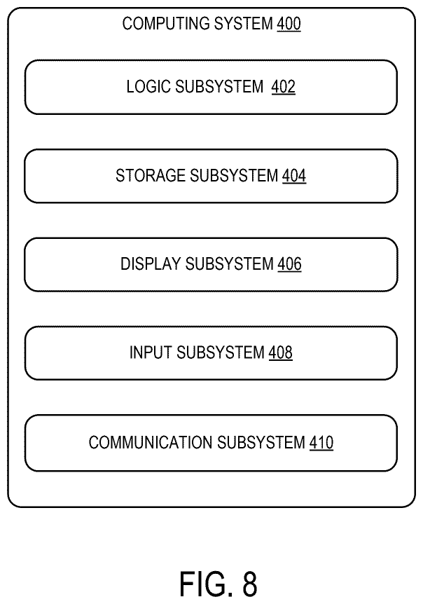

FIG. 8 schematically shows a non-limiting embodiment of a computing system 400 that can take the form of mobile computing device 100 or other computing devices manufactured or tuned as described herein. Computing system 400 is shown in simplified form. Computing system 400 can take the form of a mobile communication device (e.g., smart phone), tablet computer, wearable computing device, and/or other mobile computing device. In some examples, the mobile computing device 100 of FIGS. 1-5 comprises one or more aspects of the computing system 400.

Computing system 400 includes a logic subsystem 402, a storage subsystem 404, and a display subsystem 406. Computing system 400 can optionally include an input subsystem 408, a communication subsystem 410, and/or other components not shown in FIG. 8.

Logic subsystem 402 includes one or more physical devices configured to execute instructions. For example, logic subsystem 402 can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result.

Logic subsystem 402 can include one or more processors configured to execute software instructions. Additionally or alternatively, logic subsystem 402 can include one or more hardware or firmware logic machines configured to execute hardware or firmware instructions. Processors of logic subsystem 402 can be single-core or multi-core, and the instructions executed thereon can be configured for sequential, parallel, and/or distributed processing. Individual components of logic subsystem 402 optionally can be distributed among two or more separate devices, which can be remotely located and/or configured for coordinated processing. Aspects of logic subsystem 402 can be virtualized and executed by remotely accessible, networked computing devices configured in a cloud-computing configuration.

Storage subsystem 404 includes one or more physical devices configured to hold instructions executable by logic subsystem 402 to implement the methods and processes described herein. Storage subsystem 404 can include removable and/or built-in devices. Storage subsystem 404 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 404 can include volatile, nonvolatile, dynamic, static, read/write, read-only, random-access, sequential-access, location-addressable, file-addressable, and/or content-addressable devices.

Aspects of logic subsystem 402 and storage subsystem 404 can be integrated together into one or more hardware-logic components. Such hardware-logic components can include field-programmable gate arrays (FPGAs), program-and application-specific integrated circuits (PASIC/ASICs), program-and application-specific standard products (PSSP/ASSPs), SoCs, and complex programmable logic devices (CPLDs), for example.

When included, display subsystem 406 can be used to present a visual representation of data held by storage subsystem 404. Display subsystem 406 can include one or more display devices utilizing virtually any type of technology. Such display devices can be combined with logic subsystem 402 and/or storage subsystem 404 in a shared enclosure.

When included, input subsystem 408 can comprise or interface with one or more user-input devices such as a keyboard, mouse, touch screen, or joystick. In some embodiments, the input subsystem 408 can comprise or interface with selected natural user input (NUI) componentry. Such componentry can be integrated or peripheral, and the transduction and/or processing of input actions can be handled on-or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 410 can be configured to communicatively couple computing system 400 with one or more other computing devices. Communication subsystem 410 can include wired and/or wireless communication devices compatible with one or more different communication protocols. As non-limiting examples, the communication subsystem can be configured for communication via a wireless telephone network, or a wired or wireless local- or wide-area network. In some embodiments, communication subsystem 410 can allow computing system 400 to send and/or receive messages to and/or from other devices via a network such as the Internet. For example, communication subsystem 410 can be used receive or send data to another computing system. As another example, communication subsystem may be used to communicate with other computing systems during execution of method 800 in a distributed computing environment.

The following paragraphs provide additional support for the claims of the subject application. One aspect provides a method for tuning a spring mass resonator of a distributed mode loudspeaker in a mobile computing device, the mobile computing device comprising a display to which the spring mass resonator is affixed, the method comprising: modifying at least one component of the spring mass resonator to increase a frequency response of the display within at least a portion of a frequency range between 350 Hz. and 700 Hz. The method may additionally or alternatively include, wherein modifying the at least one component of the spring mass resonator comprises modifying the at least one component to cause a radiated sound pressure level of the distributed mode loudspeaker to continually increase within the frequency range between 350 Hz. and 700 Hz. The method may additionally or alternatively include, wherein the computing device comprises a chassis comprising a rear surface and an internal component between the rear surface and the display, wherein an upper surface of the internal component and a lower surface of the display define an air gap having a width between 0.1 mm and 0.6 mm., the air gap creating an air spring impedance that resists movement of the display. The method may additionally or alternatively include, wherein modifying the at least one component of the spring mass resonator comprises tuning the spring mass resonator from an untuned condition to a tuned condition, wherein in the untuned condition an untuned slope of a radiated sound pressure level of the distributed mode loudspeaker changes from a positive slope at a first frequency less than 350 Hz. to a negative slope at a second frequency between 350 Hz. and 700 Hz., and wherein in the tuned condition a tuned slope of the radiated sound pressure level of the distributed mode loudspeaker remains positive from the first frequency less than 350 Hz. to the second frequency between 350 Hz. and 700 Hz. The method may additionally or alternatively include, wherein modifying the at least one component of the spring mass resonator comprises adjusting a stiffness of a spring of the spring mass resonator. The method may additionally or alternatively include, wherein modifying the at least one component of the spring mass resonator comprises adjusting a mass of a mass component of the spring mass resonator. The method may additionally or alternatively include modifying the at least one component of the spring mass resonator to move a peak frequency of a fundamental mode of the display from an untuned frequency to a tuned frequency higher than the untuned frequency.

Another aspect provides method of manufacturing a mobile computing device, the mobile computing device comprising a distributed mode loudspeaker that comprises a spring mass resonator affixed to a display of the mobile computing device, a chassis comprising a rear surface, and an internal component between the rear surface and the display, the method comprising: configuring the internal component and the display to define an air gap having a width of between 0.1 mm and 0.6 mm; and modifying at least one component of the spring mass resonator to increase a frequency response of the display within at least a portion of a frequency range between 350 Hz. and 700 Hz. The method may additionally or alternatively include, wherein modifying the at least one component of the spring mass resonator comprises modifying the at least one component to cause a radiated sound pressure level of the distributed mode loudspeaker to continually increase within the frequency range between 350 Hz. and 700 Hz. The method may additionally or alternatively include, wherein modifying the at least one component of the spring mass resonator comprises tuning the spring mass resonator from an untuned condition to a tuned condition, wherein in the untuned condition an untuned slope of a radiated sound pressure level of the distributed mode loudspeaker changes from a positive slope at a first frequency less than 350 Hz. to a negative slope at a second frequency between 350 Hz. and 700 Hz., and in the tuned condition a tuned slope of the radiated sound pressure level of the distributed mode loudspeaker remains positive from the first frequency less than 350 Hz. to the second frequency between 350 Hz. and 700 Hz. The method may additionally or alternatively include, wherein modifying the at least one component of the spring mass resonator comprises adjusting a stiffness of a spring of the spring mass resonator. The method may additionally or alternatively include, wherein modifying the at least one component of the spring mass resonator comprises adjusting a mass of a mass component of the spring mass resonator. The method may additionally or alternatively include modifying the at least one component of the spring mass resonator to move a peak frequency of a fundamental mode of the display from an untuned frequency to a tuned frequency higher than the untuned frequency.

Another aspect provides a mobile computing device comprising: a distributed mode loudspeaker that comprises a spring mass resonator affixed to a display of the mobile computing device, a chassis comprising a rear surface, and an internal component between the rear surface and the display, wherein the internal component and the display are spaced apart to define an air gap having a width of between 0.1 mm and 0.6 mm; and at least one component of the spring mass resonator is configured to operatively increase a frequency response of the display within at least a portion of a frequency range between 350 Hz. and 700 Hz. The mobile computing device may additionally or alternatively include, wherein the at least one component of the spring mass resonator is configured to cause a radiated sound pressure level of the distributed mode loudspeaker to continually increase within the frequency range between 350 Hz. and 700 Hz. The mobile computing device may additionally or alternatively include, wherein the at least one component of the spring mass resonator is configured to cause a tuned slope of a radiated sound pressure level of the distributed mode loudspeaker to remain positive from 350 Hz. to 700 Hz. The mobile computing device may additionally or alternatively include, wherein the at least one component of the spring mass resonator is a mass component. The mobile computing device may additionally or alternatively include, wherein the at least one component of the spring mass resonator is a spring.

1. A method for tuning a spring mass resonator of a distributed mode loudspeaker in a mobile computing device, the mobile computing device comprising a display to which the spring mass resonator is affixed, the method comprising:
modifying at least one component of the spring mass resonator to increase a frequency response of the display within at least a portion of a frequency range between 350 Hz. and 700 Hz.

2. The method of claim 1, wherein modifying the at least one component of the spring mass resonator comprises modifying the at least one component to cause a radiated sound pressure level of the distributed mode loudspeaker to continually increase within the frequency range between 350 Hz. and 700 Hz.

3. The method of claim 1, wherein the computing device comprises a chassis comprising a rear surface and an internal component between the rear surface and the display, wherein an upper surface of the internal component and a lower surface of the display define an air gap having a width between 0.1 mm and 0.6 mm., the air gap creating an air spring impedance that resists movement of the display.

4. The method of claim 1, wherein modifying the at least one component of the spring mass resonator comprises tuning the spring mass resonator from an untuned condition to a tuned condition,
wherein in the untuned condition an untuned slope of a radiated sound pressure level of the distributed mode loudspeaker changes from a positive slope at a first frequency less than 350 Hz. to a negative slope at a second frequency between 350 Hz. and 700 Hz., and
wherein in the tuned condition a tuned slope of the radiated sound pressure level of the distributed mode loudspeaker remains positive from the first frequency less than 350 Hz. to the second frequency between 350 Hz. and 700 Hz.

5. The method of claim 1, wherein modifying the at least one component of the spring mass resonator comprises adjusting a stiffness of a spring of the spring mass resonator.

6. The method of claim 1, wherein modifying the at least one component of the spring mass resonator comprises adjusting a mass of a mass component of the spring mass resonator.

7. The method of claim 1, further comprising modifying the at least one component of the spring mass resonator to move a peak frequency of a fundamental mode of the display from an untuned frequency to a tuned frequency higher than the untuned frequency.

8. A method of manufacturing a mobile computing device, the mobile computing device comprising a distributed mode loudspeaker that comprises a spring mass resonator affixed to a display of the mobile computing device, a chassis comprising a rear surface, and an internal component between the rear surface and the display, the method comprising:
configuring the internal component and the display to define an air gap having a width of between 0.1 mm and 0.6 mm; and
modifying at least one component of the spring mass resonator to increase a frequency response of the display within at least a portion of a frequency range between 350 Hz. and 700 Hz.

9. The method of claim 8, wherein modifying the at least one component of the spring mass resonator comprises modifying the at least one component to cause a radiated sound pressure level of the distributed mode loudspeaker to continually increase within the frequency range between 350 Hz. and 700 Hz.

10. The method of claim 8, wherein modifying the at least one component of the spring mass resonator comprises tuning the spring mass resonator from an untuned condition to a tuned condition, wherein in the untuned condition an untuned slope of a radiated sound pressure level of the distributed mode loudspeaker changes from a positive slope at a first frequency less than 350 Hz. to a negative slope at a second frequency between 350 Hz. and 700 Hz., and in the tuned condition a tuned slope of the radiated sound pressure level of the distributed mode loudspeaker remains positive from the first frequency less than 350 Hz. to the second frequency between 350 Hz. and 700 Hz.

11. The method of claim 8, wherein modifying the at least one component of the spring mass resonator comprises adjusting a stiffness of a spring of the spring mass resonator.

12. The method of claim 8, wherein modifying the at least one component of the spring mass resonator comprises adjusting a mass of a mass component of the spring mass resonator.

13. The method of claim 8, further comprising modifying the at least one component of the spring mass resonator to move a peak frequency of a fundamental mode of the display from an untuned frequency to a tuned frequency higher than the untuned frequency.

14. A mobile computing device comprising:
a distributed mode loudspeaker that comprises a spring mass resonator affixed to a display of the mobile computing device,
a chassis comprising a rear surface, and
an internal component between the rear surface and the display,
wherein the internal component and the display are spaced apart to define an air gap having a width of between 0.1 mm and 0.6 mm; and
at least one component of the spring mass resonator is configured to operatively increase a frequency response of the display within at least a portion of a frequency range between 350 Hz. and 700 Hz.

15. The mobile computing device of claim 14, wherein the at least one component of the spring mass resonator is configured to cause a radiated sound pressure level of the distributed mode loudspeaker to continually increase within the frequency range between 350 Hz. and 700 Hz.

16. The mobile computing device of claim 14, wherein the at least one component of the spring mass resonator is configured to cause a tuned slope of a radiated sound pressure level of the distributed mode loudspeaker to remain positive from 350 Hz. to 700 Hz.

17. The mobile computing device of claim 14, wherein the at least one component of the spring mass resonator is a mass component.

18. The mobile computing device of claim 14, wherein the at least one component of the spring mass resonator is a spring.

19. The method of claim 1, wherein modifying the at least one component of the spring mass resonator comprises adjusting a stiffness of a spring of the spring mass resonator and adjusting a mass of a mass component of the spring mass resonator.

20. The method of claim 8, wherein modifying the at least one component of the spring mass resonator comprises adjusting a stiffness of a spring of the spring mass resonator and adjusting a mass of a mass component of the spring mass resonator.
